(19) United States
(12) Patent Application Publication
(10) Pub. No.: US 2013/0040174 A1
(43) Pub. Date: Feb. 14, 2013

(54) BATTERY PACK

(71) Applicants: Hiroshi Takasaki, Osaka (JP); Shunsuke Yasui, Osaka (JP); Shinya Geshi, Osaka (JP); Takashi Nakagawa, Osaka (JP); Keisuke Naito, Osaka (JP)

(72) Inventors: Hiroshi Takasaki, Osaka (JP); Shunsuke Yasui, Osaka (JP); Shinya Geshi, Osaka (JP); Takashi Nakagawa, Osaka (JP); Keisuke Naito, Osaka (JP)

(21) Appl. No.: 13/577,377

(22) PCT Filed: Nov. 22, 2011
(86) PCT No.: PCT/JP2011/006513

§ 371 Date: Aug. 6, 2012

(30) Foreign Application Priority Data
Nov. 30, 2010 (JP) 2010-267211

(51) Int. Cl. H01M 2/12

(52) U.S. Cl. 429/82

(57) ABSTRACT

A module case 23 is provided with a first outlet opening 35 and a first inlet opening 37 formed in side surfaces of the module case 23 opposite to each other. A plurality of battery modules 21 are arranged in a direction to which the first outlet opening 35 is open. The first outlet opening 35 of one of the battery modules 21 is connected to the first inlet opening 37 of an adjacent battery module 21 through a connecting member 57.

### TECHNICAL FIELD

The present disclosure relates to battery packs in which a plurality of battery modules are arranged.

### BACKGROUND ART

Reusable secondary batteries have been used as power sources of portable electronic devices, mobile telecommunication devices, etc., to save resources and energy. Use of such secondary batteries as power sources of vehicles, thermal storage, etc. has been considered to reduce an amount of fossil fuel used, an amount of CO₂ emission, etc.

Specifically, it has been considered to electrically connect secondary batteries (cells) to each other, thereby forming a battery module, and use the battery module as a power source. For example, a battery module disclosed in Patent Document 1 or 2 has a structure in which an exhaust duct is apart from a battery chamber. Thus, even if a high-temperature gas is released from a cell, normal cells can be prevented from being exposed to the high-temperature gas.

### CITATION LIST

### Patent Document

Patent Document 1: Japanese Patent Publication No. 2002-151025
Patent Document 2: Japanese Patent Publication No. 2006-244981

### SUMMARY OF THE INVENTION

### Technical Problem

There is a case in which battery modules are electrically connected to each other to form a battery pack. In this case, if outlet openings of exhaust ducts of the respective battery modules are connected to each other using an external connecting pipe, it may result in a reduction in energy density of the battery pack.

The present disclosure was made in view of the above problem, and it is an objective of the invention to provide a battery pack superior in safety without a reduction in energy density

### Solution to the Problem

A battery pack according to the present disclosure includes a plurality of battery modules in an arrangement, wherein each of the battery modules includes a plurality of cells which are arranged in a module case. The module case is separated into a battery chamber and a release chamber. The module case is provided with an outlet opening and an inlet opening. The outlet opening is open perpendicularly to an arrangement direction of the cells. The inlet opening is formed in a side surface of the module case opposite to the side surface of the module case in which the outlet opening is formed. The battery modules are arranged in a direction to which the outlet opening is open. The outlet opening is connected to the inlet opening of an adjacent battery module through a hollow connecting member.

According to such a battery pack, the length of the battery pack is only slightly increased in an arrangement direction of the battery modules. Thus, it is possible to reduce a reduction in energy density due to the provision of an exhaust path to the battery pack.

In the battery module, cells may be arranged in a single row, or may be two-dimensionally arranged. If the cells are two-dimensionally arranged, the “arrangement direction of the cells” includes two directions. If the number of rows of the cells in one direction is larger than the number of rows of the cells in the other direction, the “arrangement direction of the cells” is one of the two directions along which the larger number of rows of the cells are arranged. If the number of rows of the cells in one direction is the same as the number of rows of the cells in the other direction, the “arrangement direction of the cells” may be either one of the two directions.

### Advantages of the Invention

According to the present disclosure, it is possible to provide a battery pack superior in safety without a reduction in energy density.

### BRIEF DESCRIPTION OF THE DRAWINGS

FIG. 1 is a vertical cross section of a cell according to an embodiment of the present disclosure.

FIG. 2 is a plan view which illustrates an internal structure of a battery module according to an embodiment of the present disclosure.

FIG. 3 is an exploded perspective view of a battery pack according to an embodiment of the present disclosure.

FIG. 4 is a cross section taken along the line IV-IV of FIG. 3.

FIG. 5 is a cross section of a battery pack according to another embodiment of the present disclosure.

FIG. 6(a) is an exploded plan view of part of a battery pack according to another embodiment of the present disclosure. FIG. 6(b) is a cross section taken along the line VIB-VIB of FIG. 6(a).

FIG. 7 is an exploded plan view of part of a battery pack according to another embodiment of the present disclosure.

FIG. 8 is a cross section of a battery pack according to another embodiment of the present disclosure.

FIG. 9(a) is a plan view of a battery pack according to another embodiment of the present disclosure, and FIG. 9(b) is a cross section of the battery pack.

### DESCRIPTION OF EMBODIMENTS

Embodiments of the present disclosure will be described in detail below based on the drawings. The present disclosure is not limited to the embodiments described below.

A battery pack of an embodiment of the present disclosure includes a plurality of battery modules in an arrangement. Each of the battery modules includes a plurality of cells in an arrangement. The structures of the cells, the battery modules, and the battery pack will be sequentially described in the following description.

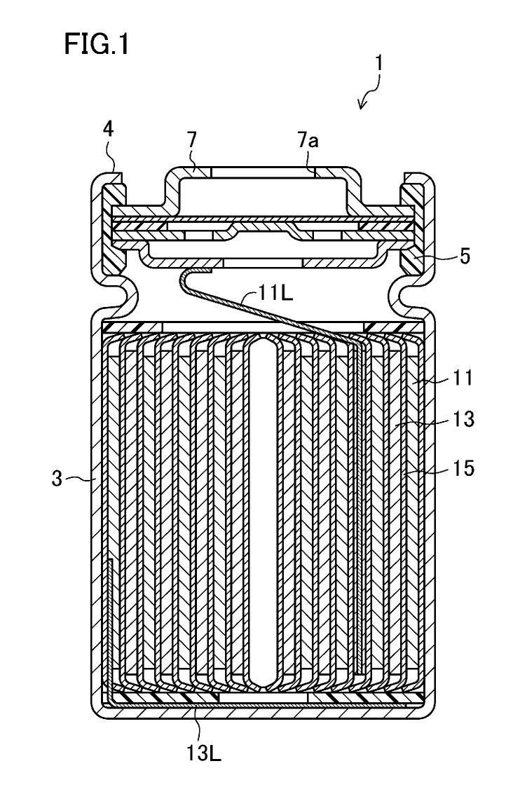

FIG. 1 is a vertical cross section of a cell according to the present embodiment.

A cell 1 according to the present embodiment is, for example, a lithium ion secondary battery, and as shown in FIG. 1, an opening of a battery case 3 is sealed with a sealing plate 7 via a gasket 5. An electrode group is accommodated in the battery case 3 together with a nonaqueous electrolyte. The electrode group is formed by winding a positive electrode plate 11 and a negative electrode plate 13 with a separator 15 interposed between the positive electrode plate 11 and the negative electrode plate 13. The positive electrode plate 11 is connected to the sealing plate 7 via a positive electrode lead 11L. The negative electrode plate 13 is connected to the battery case 3 via a negative electrode lead 13L.

A release portion 7a is formed in the sealing plate 7. The release portion 7a is an opening through which a high-temperature gas is released to the outside of the battery case 3 when a cell is in an abnormal state.

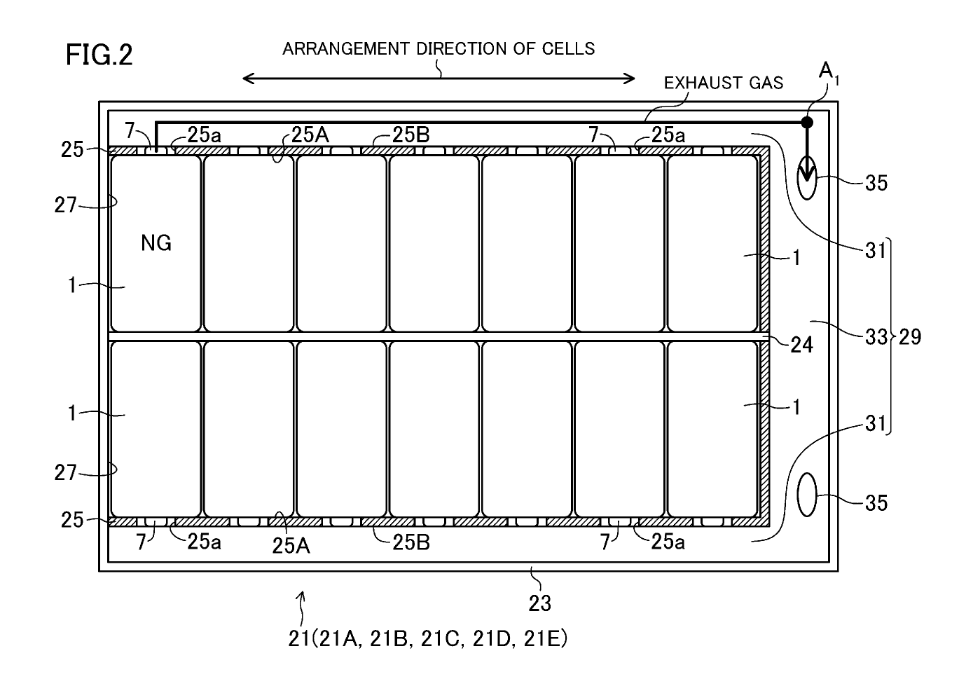

FIG. 2 is a plan view of an internal structure of a battery module 21 according to the present embodiment.

As shown in FIG. 2, the battery module 21 of the present embodiment includes a plurality of cells 1 arranged in an iron module case (a case) 23. The module case 23 is separated into two battery chambers 27, 27 and an exhaust duct 29 by partition plates 25, 25 each having an L shape in plan view. The two battery chambers 27, 27 are partitioned with a separation plate 24. The exhaust duct 29 surrounds three sides of the battery chambers 27, 27 partitioned with the separation plate 24.

Each of the battery chambers 27 are formed by an inner surface 25A of the partition plate 25, the separation plate 24, and an inner surface of the module case 23. Each of the battery chambers 27 accommodates the cells 1. The sealing plate 7 of each of the cells 1 is positioned close to the partition plate 25 (i.e., at the side of the exhaust duct 31, and at the opposite side of the separation plate 24). Thus, the bottom surfaces (i.e., opposite side of the release portion 7a) of the battery cases 3 of the cells 1 accommodated in one battery chamber 27 are opposed to the bottom surfaces of the battery cases 3 of the cells 1 accommodated in the other battery chamber 27. Part of each of the partition plates 25 which extends along the arrangement direction of the cells is provided with a plurality of through holes 25a at intervals. The sealing plate 7 of the cell 1 is exposed through each of the through holes 25a formed in the partition plate 25. Thus, the release portion 7a of the cell 1 communicates with the exhaust duct 29. Further, the peripheral edge of each of the through holes 25a formed in the partition plate 25 is in contact with a shoulder 4 of the cell 1 (see FIG. 1). Thus, the gas (hereinafter also referred to as “exhaust gas” or “high-temperature gas”) released from any of the cells 1 can be prevented from flowing back to, or flowing into the battery chamber 27. Accordingly, normal cells 1 can be prevented from being exposed to the high-temperature gas, and it is possible to provide a battery module 21 superior in safety.

The exhaust duct 29 is a space formed by outer surfaces 25B, 25B of the partition plates 25, 25 and the inner surface of the module case 23, and includes first exhaust duct portions 31 and a second exhaust duct portion 33. The first exhaust duct portions 31 extend in the arrangement direction of the cells. The second exhaust duct portion 33 communicates with the first exhaust duct portions 31, and extends in a direction perpendicular to the arrangement direction of the cells, that is, in an axial direction of the cells 1.

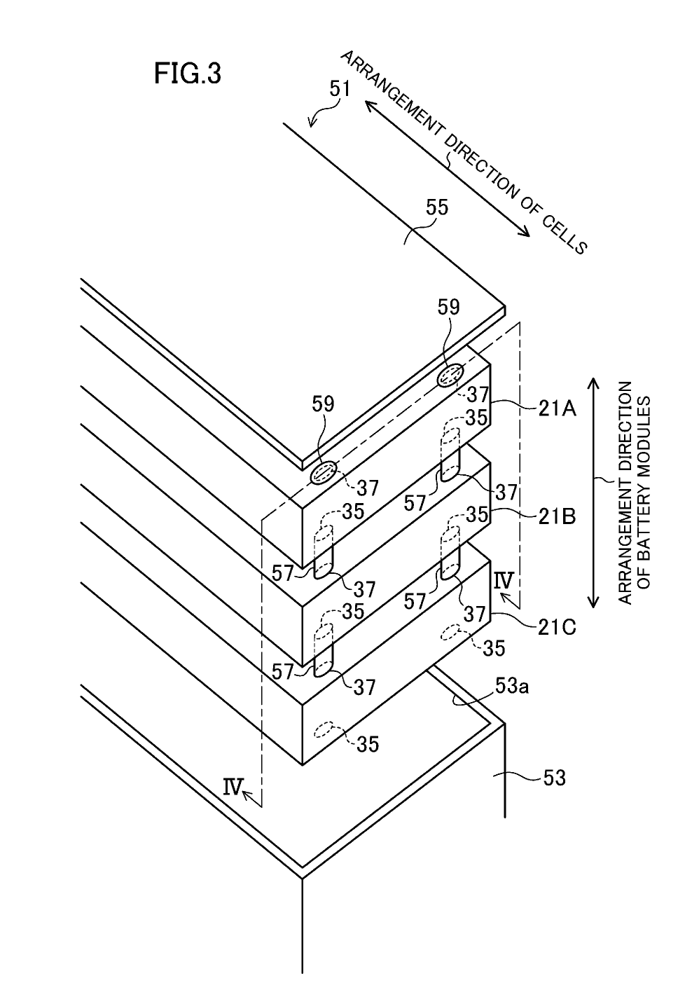

A first outlet opening (an outlet opening) 35 and a first inlet opening (an inlet opening shown in FIG. 3) 37 are provided to the second exhaust duct portion 33 at each longitudinal end of the second exhaust duct portion 33. The first outlet opening 35 is an opening through which the exhaust gas is released to the outside of the module case 23. The first outlet opening 35 is formed in the lower surface of the module case 23, and is open in a direction perpendicular to the arrangement direction of the cells. The first inlet opening 37 is an opening to which the gas released from the first outlet opening 35 of an adjacent battery module 21 in the battery pack 51 is introduced. The first inlet opening 37 is formed in an upper surface of the module case 23 (i.e., the side surface opposite to the side surface in which the outlet opening is formed).

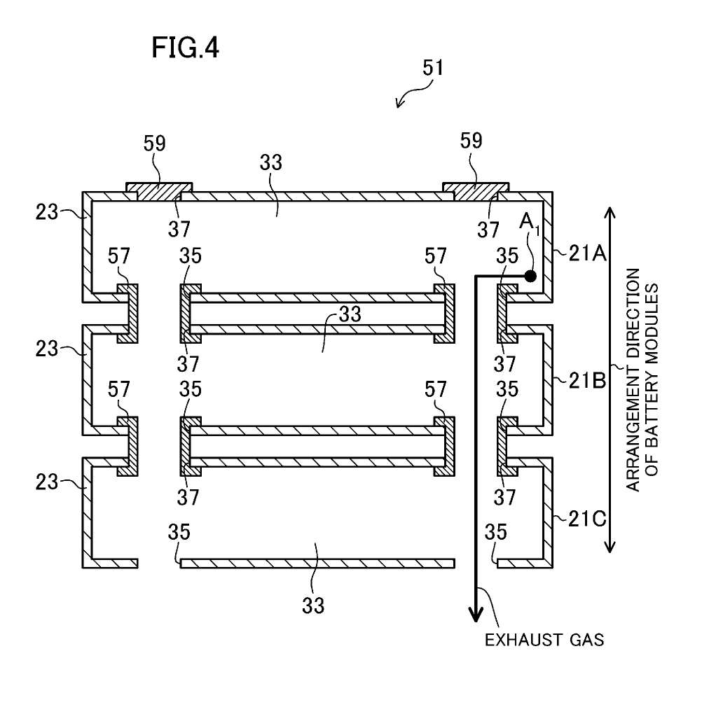

FIG. 3 is an exploded perspective view of the battery pack 51 according to the present embodiment. FIG. 4 is a cross section taken along the line IV-IV of the FIG. 3.

The battery pack 51 of the present embodiment includes, as shown in FIG. 3, a plurality of battery modules 21 and a pack case which includes an iron holding member 53 and an iron lid 55. The plurality of battery modules 21 are stacked together and accommodated in a hollow 53a of the holding member 53. The lid 55 is placed on the uppermost battery module 21A to close the opening of the hollow 53a.

The plurality of battery modules 21 are arranged in a direction to which the first outlet opening 35 and the first inlet opening 37 are open. The battery modules 21 are stacked such that the first outlet opening 35 of each of the battery modules 21 is located under the first inlet opening 37 as shown in FIG. 3 (i.e., located at a downstream side of the exhaust gas). Thus, the first outlet opening 35 of the uppermost battery module 21A faces the first inlet opening 37 of the middle battery module 21B, and the first outlet opening 35 of the middle battery module 21B faces the first inlet opening 37 of the lowermost battery module 21C, in the arrangement direction of the battery modules.

The exhaust ducts 29 of the battery modules 21 communicate with each other in the arrangement direction of the battery modules, and form an exhaust path of the battery pack 51. Specifically, as shown in FIG. 3 and FIG. 4, the first outlet openings 35 of the uppermost battery module 21A are connected to the respective first inlet openings 37 of the middle battery module 21B through connecting members 57, and the first outlet openings 35 of the middle battery module 21B are connected to the respective first inlet openings 37 of the lowermost battery module 21C through connecting members 57. Each of the connecting members 57 is a pipe made, for example, of polybutylene terephthalate (PBT), and is fixed to circumferential edges of the corresponding first outlet opening 35 and the first inlet opening 37. The first outlet openings 35 of the lowermost battery module 21C may be connected to an outlet opening (now shown) formed in the pack case.

When a cell 1 is in an abnormal state (for example, when an internal short-circuit or an external short-circuit occurs in a cell 1), a high-temperature gas may be released from the cell 1 through the release portion 7a of the sealing plate 7. For example, suppose that a high-temperature gas is released from a cell 1 in the uppermost battery module 21A (the cell 1 labeled NG in FIG. 2). As shown in FIG. 2, the released gas is released from the release portion 7a (see FIG. 1) into the first exhaust duct portion 31 of the exhaust duct 29, and flows along the longitudinal direction of the first exhaust duct portion 31 to collide with the inner surface of the module case 23 (near point A₁). The flowing direction of the exhaust gas is changed by the collision with the inner surface of the module case 23, and the exhaust gas flows in a longitudinal direction of the second exhaust duct portion 33 to be released from the first outlet opening 35. Here, the exhaust gas is considered to be released from one of the first outlet openings 35 which the gas encounters first (the upper one of the first outlet openings 35 in FIG. 2), but part of the exhaust gas may be released from the other first outlet opening 35 which the gas encounters later (the lower one of the first outlet openings 35 in FIG. 2).

The gas released from the first outlet opening 35 of the uppermost battery module 21A flows through the connecting member 57 and is introduced to the first inlet opening 37 of the middle battery module 21B to be released from the first outlet opening 35 of the middle battery module 21B, as shown in FIG. 4. Thereafter, the gas flows through the connecting member 57 and is introduced to the first inlet opening 37 of the lowermost battery module 21C, released from the first outlet opening 35 of the battery module 21C, and released to the outside of the battery pack 51 from the outlet opening formed in the pack case.

As shown in FIG. 4, it is preferable to close the first inlet openings 37 of the uppermost battery module 21A with caps 59. As a result, most of the exhaust gas can be released along the direction indicated by arrow in FIG. 4. This means that it is possible to control the flow path of the exhaust gas. Further, it is possible to prevent foreign substances from entering in the uppermost battery module 21A. The material for the caps 59 is not specifically limited, but is preferably PBT, etc.

As described above, in the present embodiment, it is possible to prevent a reduction in energy density due to the provision of the exhaust path to the battery pack 51. It is possible to provide an exhaust path to a battery pack by connecting the outlet openings of the exhaust ducts with a connecting pipe, etc. In this case, however, the connecting pipe, etc. is located outside the module case in plan view. Thus, a dead space in the battery pack (the space where no cell 1 is provided) is increased, which results in a reduction in energy density.

Another example may be that an exhaust duct for a battery pack is separately formed, and an outlet opening of a battery module may be connected to the exhaust duct. In this case, however, it is difficult to connect the outlet opening to the exhaust duct for the battery pack if variations in the position of the outlet opening in the battery module occur. Thus, productivity of the battery pack may be decreased.

On the other hand, in the battery pack 51 of the present embodiment, the plurality of battery modules 21 are arranged in a direction to which the first outlet opening 35 is open, and the first outlet opening 35 is connected to the first inlet opening 37 of the adjacent battery module 21 through the connecting member 57. This means that the connecting member 57 is located inside the module case 23 in plan view. Thus, in the present embodiment, the length of the battery pack 51 in the arrangement direction of the battery modules is increased only by the length of the connecting member 57. As a result, it is possible to prevent a reduction in energy density due to the provision of the exhaust path to the battery pack. The length of the connecting member 57 connecting adjacent battery modules 21, 21 is 10 mm or less, that is, 4 mm, for example.

Further, a refrigerant can be made to flow in a space between the battery modules 21, 21 which is formed as a result of the provision of the connecting member 57, thereby making it possible to cool the battery modules 21. The space can be effectively used. In this case, it is preferable to provide a spacer between the adjacent battery modules 21, 21 to ensure the space for the flowing refrigerant, and ensure stable positioning of the battery module 21 to a predetermined location.

Further, in the battery pack 51 of the present embodiment, the connecting member 57 does not extend from the upstream side to the downstream side of the exhaust gas, but connect the first outlet opening 35 of one battery module 21 to the first inlet opening 37 of another battery module 21 adjacent to the one battery module 21. Thus, the battery pack 51 can be formed even if variations in the position of the first outlet opening 35 or the first inlet opening 37 in the module case 23 occur.

In the battery pack 51 of the present embodiment, the exhaust gas is released along the arrangement direction of the battery modules. Thus, cooling is provided by utilizing the height in which the battery modules 21 are arranged. The longer the length of the exhaust path of the battery pack 51, the lower the temperature of the gas released from the battery pack 51. The inventors of the present application have checked that in the case where a gas whose temperature is 1000° C. or more is released from a cell 1, the temperature of the gas released from the first outlet opening 35 of the lowermost battery module 21 will be 100° C. or less if the distance is 220 mm or more between the point A₁ of the battery module 21 which includes the cell 1 from which the gas has been released (hereinafter referred to as an “abnormal battery module”) and the first outlet opening 35 of the lowermost battery module 21. Further, the inventors of the present application have checked that even in the case where a gas (e.g., a reactive gas) which easily reacts with oxygen in the air is released from a cell 1, it is possible to prevent a severe reaction between the reactive gas and the oxygen in the air if the temperature of the reactive gas at the time of release from the battery pack 51 is 400° C. or less. Accordingly, in the present embodiment, it is possible to prevent a severe reaction between the gas released from the battery pack 51 and oxygen in the air, and possible to provide a battery pack 51 superior in safety.

Further, in each of the battery modules 21 of the present embodiment, the first outlet opening 35 is open in a direction perpendicular to the arrangement direction of the cells. Thus, in an abnormal battery module 21, the high-temperature gas collides with the inner surface of the module case 23 more than once, and is then released from the first outlet opening 35. The inventors of the present application have checked that the greater the frequency of collision of the exhaust gas with the inner side surface of the module case 23 or the inner side surface of the pack case, the lower temperature gas is released from the battery pack. Thus, in the present embodiment, the entire length of the exhaust duct 29 (i.e., a total length of the lengths of the first exhaust duct portions 31 and the length of the second exhaust duct portion 33) does not have to be that long in order to reduce the temperature of the gas released from the battery module 21 to about 300 to 400° C. Accordingly, it is possible to reduce the temperature of the gas released from the battery module 21 without a reduction in energy density of the battery module 21. For example, if the exhaust duct is made of a long-length pipe, the length of the pipe needs to be 2 to 3 m in order to reduce the temperature of the exhaust gas from 1000° C. or more to about 300 to 400° C. However, if the exhaust duct is made of the exhaust duct 29 of the present embodiment, it is possible to reduce the temperature of the exhaust gas from 1000° C. or more to about 300 to 400° C. even if the entire length of the exhaust duct 29 is less than 2 m.

That is, in the present embodiment, if the temperature of the gas released from a cell 1 is 1000° C. or more, the temperature of the gas released from the abnormal battery module 21 is about 400° C. Accordingly, the temperature of the gas released from the battery pack 51 is 400° C. or less. Thus, it is possible to prevent a severe reaction between the gas released from the battery pack 51 and oxygen in the air. Further, if the distance between the point A₁ in the abnormal battery module 21 and the outlet opening formed in the pack case is 220 mm or more (for example, when a high-temperature gas is released from a cell 1 included in an upstream side battery module), the temperature of the gas released from the battery pack 51 is 100° C. or less.

Moreover, since each of the module cases 23 and the pack case are made of iron, the exhaust gas can be efficiently cooled.

Further, in the battery pack 51 of the present embodiment, the exhaust path can be collected at one side (at the right end side in FIG. 3). Thus, the exhaust path and an electric system, such as a signal line, can be separated from each other by placing the electric system opposite to the exhaust path. As a result, the electric system can be prevented from being exposed to the high-temperature gas.

Further, in each of the battery modules 21 of the present embodiment, the battery chamber 27 is separated from the exhaust duct 29 by the partition plate 25. With this structure, it is possible to prevent a high-temperature gas released from a cell 1 from flowing back to, or flowing into the battery chamber 27. This means that the normal cell 1 can be prevented from being exposed to the high-temperature gas, and as a result, the safety of the battery module 21 can be increased.

Here, the cross-sectional area of the exhaust path of the battery pack 51 will be described.

As the cross-sectional area of the exhaust path is reduced, it becomes less easy to release the exhaust gas, and this may result in pressure loss. If the pressure loss occurs, the exhaust gas may flow back. Further, the battery pack 51 or the battery module 21 may also be damaged. The damage may cause damage to the cells 1. For these reasons, it is preferable that the cross-sectional area of the exhaust path is large.

On the other hand, if the exhaust path has a large cross-sectional area, the ratio of the exhaust gas which collides with the inner surface of the exhaust path decreases. As a result, the exhaust gas is less easily cooled. Moreover, if the exhaust path has a large cross-sectional area, the battery module or the battery pack is increased in size, which results in a reduction in energy density of the battery pack.

It is preferable to decide the cross-sectional area of the exhaust path in view of the above matters. The inventors of the present application consider that the pressure loss is not caused and the exhaust gas can be cooled if the cross-sectional area of the exhaust path is 400 mm² or more and 500 mm² or less. That is, the cross-sectional area of each of the first exhaust duct portions 31, the second exhaust duct portion 33, and the connecting members 57 is preferably 400 mm² or more and 500 mm² or less.

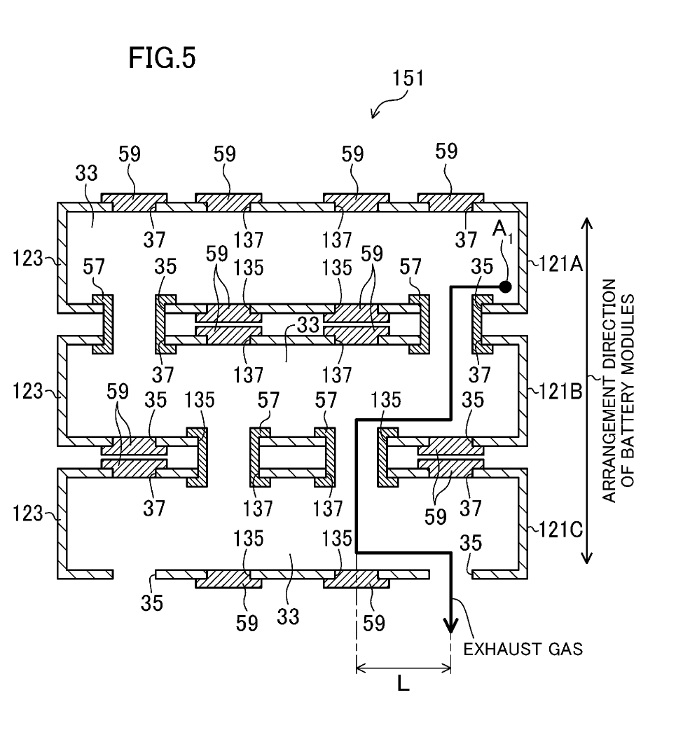

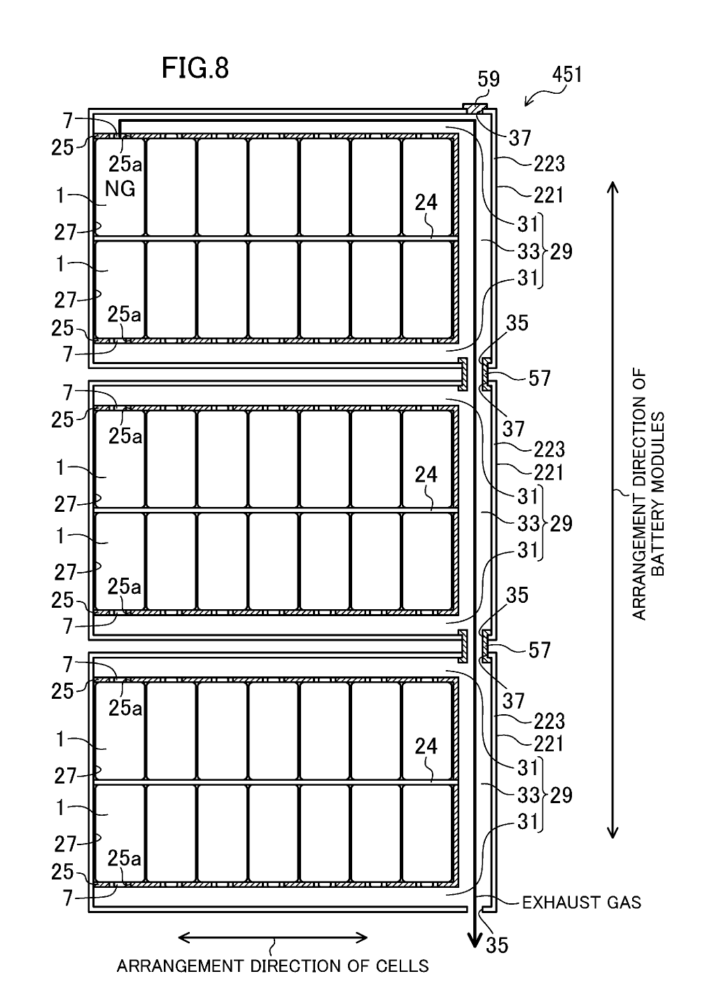

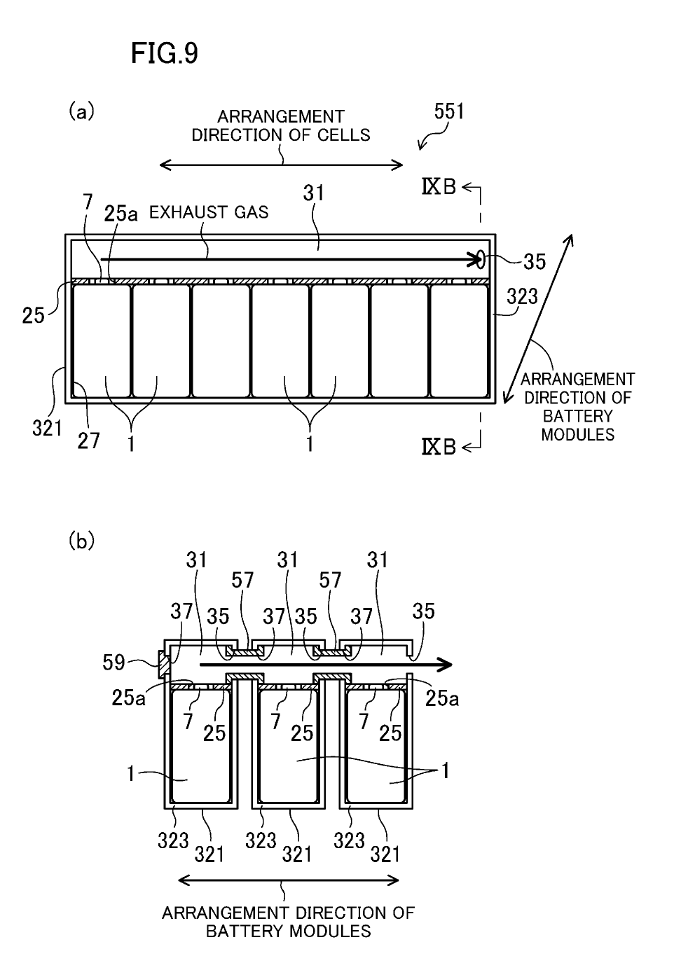

If the battery pack has a structure as shown, for example, in FIG. 5 to FIG. 7, the exhaust path of the battery pack can be further elongated. The same advantage can also be obtained if the battery module has a structure as shown in FIG. 8 to FIG. 9. The structures will be sequentially described.

FIG. 5 is a cross section of a battery pack 151 according to the first variation. The battery pack 51 and the battery pack 151 are different from each other in the structure of the exhaust path in the arrangement direction of the battery modules. Differences from the battery pack 51 will be mainly described below.

The battery pack 151 includes battery modules 121 (the reference character of the battery modules is “121” if locations of the battery modules in the battery pack 151 are not specified) in an arrangement. Not only first outlet openings 35, 35, but also second outlet openings 135, 135 are formed in a lower surface of a module case 123 of each of the battery modules 121. Similarly, not only first inlet openings 37, 37, but also second inlet openings 137, 137 are formed in an upper surface of each of the module cases 123. Each of the first inlet openings 37 is formed at a location opposite to the corresponding one of the first outlet openings 35. Each of the second inlet openings 137 is formed at a location opposite to the corresponding one of the second outlet openings 135.

In the battery pack 151, each first outlet opening 35 faces the first inlet opening 37 formed in the adjacent battery module 121. Each second outlet opening 135 faces the second inlet opening 137 formed in the adjacent battery module 121. As shown in FIG. 5, the uppermost battery module 121A and the middle battery module 121B communicate with each other by the first outlet openings 35 and the first inlet openings 37 connected through connecting members 57. The middle battery module 121B and the lowermost battery module 121C communicate with each other by the second outlet openings 135 and the second inlet opening 137 connected through the connecting members 57.

The second outlet openings 135, the first inlet openings 37, and the second inlet openings 137 of the uppermost battery module 121A, the first outlet openings 35 and the second inlet openings 137 of the middle battery module 121B, and the first inlet openings 37 and the second outlet openings 135 of the lowermost battery module 121C are preferably closed by caps 59. As a result, it is possible to control the flow path of the exhaust gas, and possible to prevent entrance of foreign substances.

When the uppermost battery module 121A is an abnormal battery module, the high-temperature gas released from a cell 1 is released to the point A₁, at which the flow direction is changed as shown in FIG. 2. After that, the high-temperature gas passes through the connecting member 57, and is released from the first outlet opening 35 of the uppermost battery module 121A to the first inlet opening 37 of the middle battery module 121B. The first outlet opening 35 of the middle battery module 121B is closed by the cap 59, whereas the second outlet opening 135 of the battery module 121B is open. Thus, the exhaust gas is released from the second outlet opening 135 of the middle battery module 121B to the second inlet opening 137 of the lowermost battery module 121C through the connecting member 57. The second outlet opening 135 of the lowermost battery module 121C is closed by the cap 59, whereas the first outlet opening 35 of the battery module 121C is open. Thus, the exhaust gas is released to the outside of the battery pack 151 through the first outlet opening 35 of the lowermost battery module 121C.

Accordingly, the release path of the battery pack 151 is longer than the release path of the battery pack 51 by about “2 L.” Here, the length “L” is a distance between a center point of the first outlet opening 35 and a center point of the second outlet opening 135. With this structure, the temperature of the gas released from the battery pack 151 is lower than the temperature of the gas released from the battery pack 51. However, the total volume of the battery pack 51 and the total volume of the battery pack 151 are not much different. Accordingly, it is possible to improve safety with almost no reduction in energy density in the battery pack 151, compared to in the battery pack 51.

Each of the battery modules 121 may be provided with a third outlet opening, a fourth outlet opening, . . . , and an n^{th} outlet opening. The larger the number of n, the longer the release path of the battery pack 151 can be. However, if the number of n is large, the number of outlet openings and inlet openings to be closed is increased. This may cause a reduction in productivity of the battery pack, and further result in an increase in cost of the battery pack. Moreover, the strength of the module case may also be reduced. It is preferable to decide the number of n in view of these matters.

The length L is not specifically limited. The length L may be decided in view of productivity of the module cases, while ensuring the length of the exhaust path and the strength of the module case.

Further, the uppermost battery module 121A and the middle battery module 121B may communicate with each other by the second outlet openings 135 and the second inlet openings 137 connected through the connecting members 57, and the middle battery module 121B and the lowermost battery module 121C may communicate with each other by the first outlet openings 35 and the first inlet openings 37 connected through the connecting members 57.

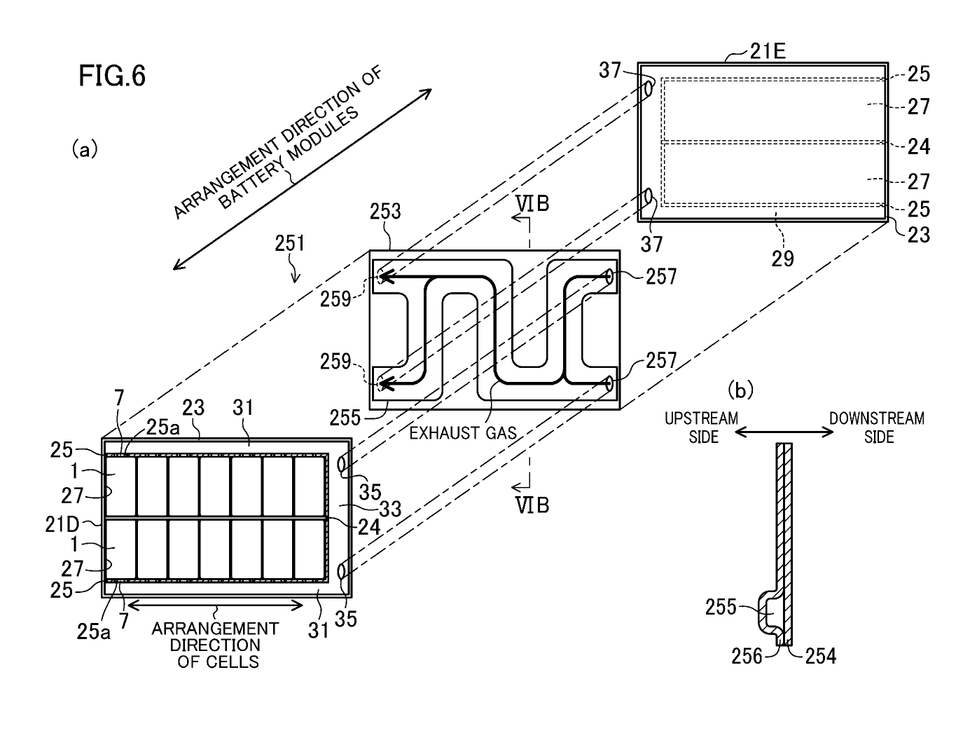

FIG. 6 is an exploded plan view of part of a battery pack 251 according to the second variation. FIG. 6(b) is a cross section taken along the line VIB-VIB of FIG. 6(a). In FIG. 6(a), an internal structure of a battery module 21D is shown in solid line, and part of an internal structure of a battery module 21E is shown in broken line. The battery pack 51 and the battery pack 251 are different from each other in the structure of a connecting member. Differences from the battery pack 51 will be mainly described below.

In the battery pack 251, a connecting member 253 includes two sheet members 254, 256 with a hollow space 255 therebetween, as shown in FIG. 6(b). The hollow space 255 has a curved shape in plan view. Two upstream side openings 257, 257 are formed at one end of the hollow space 255, and two downstream side openings 259, 259 are formed at the other end of the hollow space 255. Each of the upstream side openings 257 is formed in the upper surface of the connecting member 253, and communicates with the hollow space 255 and a corresponding one of the first outlet openings 35 of the battery module 21D (the upstream side battery module) located at the upstream side of the connecting member 253. Each of the downstream side openings 259 is formed in the lower surface of the connecting member 253, and communicates with the hollow space 255 and a corresponding one of first inlet openings 37 of the battery module 21E (the downstream side battery module) located at the downstream side of the connecting member 253. It is preferable that each of the upstream side openings 257 communicates with the first outlet opening 35 of the upstream side battery module 21D via a short-length communicating pipe (not shown), etc. The same holds true of the downstream side openings 259.

In such a battery pack 251, the gas released from the first outlet openings 35 of the upstream side battery module 21D is led to the upstream side openings 257, and flows along a longitudinal direction of the hollow space 255 to be released to the first inlet openings 37 of the downstream side battery module 21E through the downstream side openings 259. Here, the hollow space 255 has a curved shape in plan view as shown in FIG. 6(a). The upstream side openings 257 are located at one end of the hollow space 255 in the longitudinal direction. The downstream side openings 259 are located at the other end of the hollow space 255 in the longitudinal direction. Thus, the length of the exhaust path of the battery pack 251 is longer than the length of the battery pack 51 by the length of the hollow space 255 in the longitudinal direction. Accordingly, the temperature of the gas released from the battery pack 251 is lower than the temperature of the gas released from the battery pack 51.

It is preferable to use the connecting member 253 in order to elongate the exhaust path of the battery pack. However, if the connecting member 253 is used, separate members for connecting the connecting member 253 with the battery modules 21 are necessary. Thus, the productivity of the battery pack may be reduced, or the cost for the battery pack may be increased. Whether to use the connecting member 57 or the connecting member 253 may be decided in consideration of the safety of the battery pack and the productivity and cost of the battery pack.

For example, the connecting member 253 is preferably located at a downstream side. With this structure, even if a high-temperature gas is released from a cell 1 included in the downstream side battery module 21, the temperature of the gas released from the battery pack 251 is 100° C. or less.

Further, even-numbered connecting members 253 may be provided between adjacent battery modules 21, 21. With this structure, the first outlet openings 35 and the first inlet openings 37 can be provided at the same side in the battery pack 251. Accordingly, it is possible to separate the gas exhaust path from the electric system, such as lines, etc., in the battery pack 251, as well.

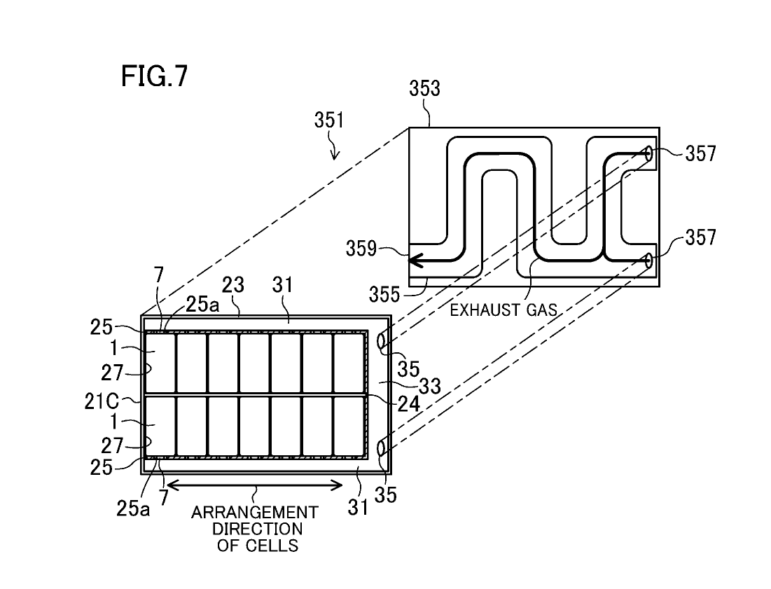

Further, the plan view of the hollow space 255 is not limited to the plan view shown in FIG. 6(a). For example, the hollow space 255 in plan view may have a straight shape, or may have a curved shape different from the curved shape shown in FIG. 6(a). If the hollow space 255 has a curved shape in plan view, the exhaust gas flows along the longitudinal direction of the hollow space 255, while colliding with the inner surface of the hollow space 255, and it is possible to elongate the hollow space 255 within a limited space. For these reasons, it is preferable that the hollow space 255 has a curved shape in plan view, and much preferable if the hollow space 255 is wound as shown in FIG. 6(a). The same holds true of a second hollow space 355 in FIG. 7 described later.

Further, the positions of the upstream side openings 257 and the downstream side openings 259 are not limited to the positions in FIG. 6(a). If the upstream side openings 257 and the downstream side openings 259 are located at different positions of the hollow space 255 in the longitudinal direction of the hollow space 255, the length of the exhaust path of the battery pack 251 can be longer than the exhaust path of the battery pack 51. However, if the upstream side openings 257 are provided at one end of the hollow space 255 in the longitudinal direction, and the downstream side openings 259 are provided at the other end of the hollow space 255 in the longitudinal direction, the length of the exhaust path of the battery pack 251 can be the longest. The same holds true of openings (first openings) 357 and a release end (a second opening) 359 in FIG. 7 described later.

Further, the structure of the connecting member 253 is not limited to the structure shown in FIG. 6(b). For example, the sheet member 256 may also have a projection and a depression, and the hollow space 255 may be formed by adhering this sheet member 256 to the sheet member 254 shown in FIG. 6(b). The same holds true of a lower panel (a panel) 353 in FIG. 7 described later.

Further, the materials for the sheet members 254, 256 are not specifically limited. For example, the sheet members 254, 256 may be made of a galvanized sheet iron, etc. It is preferable to use an electrolytic galvanized sheet (SECC) as the galvanized sheet iron.

FIG. 7 is an exploded plan view of part of a battery pack 351 according to the third variation. FIG. 7 shows an internal structure of a lowermost battery module 21C. The battery pack 351 according to the present variation further includes a lower panel 353. Differences from the battery pack 51 will be mainly described below.

The lower panel 353 is provided between the lowermost battery module 21C and a bottom surface of a holding member 53, and includes two sheet members (not shown) with a second hollow space 355 therebetween (see FIG. 6(b)). The second hollow space 355 has a curved shape in plan view. Two openings 357, 357 are formed at one end of the second hollow space 355, and a release end 359 is formed at the other end of the second hollow space 355. Each of the openings 357 is formed in the upper surface of the lower panel 353, and communicates with the second hollow space 355 and a corresponding one of the first outlet openings 35 of the lowermost battery module 21C. The release end 359 communicates with the second hollow space 355 and an outlet opening formed in the pack case.

In such a battery pack 351, the gas released from each of the first outlet openings 35 of the lowermost battery module 21C is led to the openings 357, and flows along a longitudinal direction of the second hollow space 355 to be released from the release end 359. Thus, the length of the exhaust path of the battery pack 351 is longer than the length of the battery pack 51 by the length of the second hollow space 355 in the longitudinal direction. Accordingly, the temperature of the gas released from the battery pack 351 is lower than the temperature of the gas released from the battery pack 51. For example, even if a high-temperature gas is released from a cell 1 included in the lowermost battery module 21C, the temperature of the gas released from the battery pack 351 can be lower than 100° C. or less.

It is preferable to use the lower panel 353 in order to elongate the exhaust path of the battery pack, and preferable to provide a larger number of lower panels 353. However, if the lower panel 353 is used, a separate member for connecting the lower panel 353 and the lowermost battery module 21C is necessary. Thus, the productivity of the battery pack may be reduced, or the cost for the battery pack may be increased. Further, if the number of lower panels 353 is increased, it results in a reduction in energy density of the battery pack. Whether to provide the lower panel 353 or not, or the number of lower panels 353 may be decided in view of these matters.

FIG. 8 is a cross section of a battery pack 451 according to the fourth variation. In FIG. 8, the outside shape of each cell 1 is illustrated for simplification of the drawing. Differences from the battery module 21 and the battery pack 51 will be mainly described below.

In each of battery modules 221, a first outlet opening 35 is formed in the front face of a module case 223. A first inlet opening 37 is formed in the back face of the module case 223. The battery pack 451 includes the battery modules 221 arranged in a direction to which the first outlet opening 35 is open.

In such a battery pack 451, the gas released from a cell 1 (the cell 1 labeled NG in FIG. 8) is released from a release portion 7a to a first exhaust duct portion 31, and flows along the longitudinal direction of the first exhaust duct portion 31 to collide with the inner side surface of the module case 223. The flowing direction of the exhaust gas is changed by this collision with the inner side surface of the module case 223. The exhaust gas flows along the longitudinal direction of the second exhaust duct portion 33, and is released through the first outlet opening 35 to be led to the first inlet opening 37 formed in an adjacent battery module 221. Accordingly, approximately the same advantages as the advantages obtained in the battery pack 51 shown in FIG. 3, etc., can be obtained in the battery pack 451.

FIGS. 9(a) and 9(b) show a plan view and a cross section of a battery pack 551 according to the fifth variation. FIG. 9(a) shows an internal structure of a battery module 321. In FIG. 9(b), the outside shape of each cell 1 is illustrated for simplification of the drawing. Differences from the battery module 21 and the battery pack 51 will be mainly described below.

The module case 323 of each battery module 321 is separated into one battery chamber 27 and a long-length exhaust duct 29. A first outlet opening 35 is formed in an upper surface of the module case 323. A first inlet opening 37 is formed in a lower surface of the module case 323. The battery pack 551 includes the battery modules 321 arranged in a direction in to which the first outlet opening 35 is open.

In such a battery pack 551, the gas released from a cell 1 is released from a release portion 7a to the exhaust duct 29, and flows along a longitudinal direction of the exhaust duct 29 to collide with an inner side surface of the module case 323. The flowing direction of the exhaust gas is changed by this collision, and the exhaust gas is released through the first outlet opening 35 to be led to the first inlet opening 37 formed in an adjacent battery module 321. Accordingly, approximately the same advantages as the advantages obtained in the battery pack 51 shown in FIG. 3, etc., can be obtained in the battery pack 551.

The present embodiment may have the following structures.

The battery packs shown in FIG. 6 to FIG. 9 may have the exhaust path shown in FIG. 5. Further, each of the battery packs shown in FIG. 5 and FIG. 7 to FIG. 9 may have the connecting member 253 shown in FIG. 6, in place of the connecting member 57. Further, each of the battery packs shown in FIG. 5 to FIG. 6 and FIG. 8 to FIG. 9 may have the lower panel 353 shown in FIG. 7. In any of these cases, the exhaust path of the battery pack can be elongated. Thus, the safety of the battery pack is further increased.

The first outlet opening may be open to the arrangement direction of the cells. However, if the first outlet opening is open perpendicularly to the arrangement direction of the cells, the frequency of collision of the exhaust gas with the inner side surface of the module case can be increased. As a result, it is possible to reduce the temperature of the gas released from an abnormal battery module to about 400° C.

The positions of the battery chamber and the exhaust duct in the module case may be different from the positions of the battery chamber and the exhaust duct shown in FIG. 2 and FIG. 9. In the cases where the positions of the battery chamber and the exhaust duct in the module case is as shown in FIG. 2, it is possible to form not only the battery pack shown in FIG. 4, but also the battery pack shown in FIG. 8. Thus, it is possible to provide a variety of battery packs.

In the battery module shown in FIG. 2, the first outlet opening may be provided in the middle portion of the second exhaust duct portion in the longitudinal direction. With this structure, the length of movement of the exhaust gas in the battery module is increased, and the temperature of the gas released from an abnormal battery module is further reduced. In this case, each module case may have two first outlet openings, or one first outlet opening.

The first outlet opening and the first inlet opening connected together by the connecting member may be provided at positions facing each other (the former structure), or may be provided at positions not facing each other (the latter structure). The former structure is preferable in view of easiness in fixing the connecting member, or a reduction in pressure loss in the connecting member. However, the latter structure may also be used if the misalignment is not more than manufacturing dispersion. The same holds true of the second outlet opening and the second inlet opening connected together by the connecting member.

Similarly, in the battery module, the first outlet opening may be provided at a position not facing the first inlet opening. It is preferable to provide the first outlet opening at a position facing the first inlet opening so that the gas from the first inlet opening can be released through the first outlet opening without much pressure loss. However, the first outlet opening may be provided at a location not facing the first inlet opening if the misalignment is not more than manufacturing dispersion. The same holds true of the second outlet opening.

The technique for fixing the connecting member to the circumferential edge of the first outlet opening, etc., is not specifically limited. If the connecting member is made of resin such as PBT, example methods for fixing the connecting member includes caulking.

The shape of the first outlet opening is not limited to the shape shown in FIG. 3, etc. The number of the first outlet openings is not limited to the number described above. The same holds true of the first inlet opening, the second outlet opening, the second inlet opening, the upstream side opening, the downstream side opening, the opening, and the release end.

The structure of the pack case is not limited to the structure shown in FIG. 3. Further, the structure of the module case is not specifically limited, and may be formed to have approximately the same shape as the shape of the pack case in FIG. 3.

The pack case may be replaced by a structure formed by a hollow frame member. In this case, it is possible to further increase the length of the exhaust path of the battery pack without a reduction in energy density of the battery pack, by connecting an outlet opening of a downstream side battery module to the hollow space of the frame member.

The pack case may be made of resin, or may be made of a highly thermal-conductive material (e.g., a metallic material such as iron or copper). If the pack case is made of a highly thermal-conductive material, part of heat of the exhaust gas can be dissipated to the pack case. Accordingly, the pack case is preferably made of a highly thermal-conductive material. Further, if the pack case is made of iron, it is possible to reduce the weight of the pack case. The same holds true of the module case.

The separation plate may not be provided. However, it is said that if a high-temperature gas is released from a cell, the temperature of the cell is increased to about 300 to 600°, and therefore, the provision of the separation plate, particularly the separation plate made of a highly thermal-conductive material, can prevent the abnormal heat of the cell from being transmitted to the cells in the other battery chamber. For the similar reason, it is preferable that the plurality of cells are held in a holder made of a highly thermal-conductive material (e.g., aluminum) and accommodated in the module case.

The number of battery modules included in the battery pack is not limited to the number illustrated in FIG. 3, etc. Further, the battery modules may be stacked to form the battery pack, or the battery modules are arranged horizontally to form the battery pack. Further, in the battery pack, the battery modules may be connected together in parallel, or may be connected together in series. The structure for electrically connecting the plurality of battery modules together is not specifically limited.

Similarly, the number of the cells included in the battery module is not limited to the number illustrated in FIG. 2, etc. Further, in the module case, the plurality of cells may be arranged in a single row, or may be two-dimensionally arranged. If the plurality of cells are arranged in a staggered manner, it is possible to prevent an increase in volume of the battery module due to the increase in the number of the cells. Further, in the module case, the plurality of cells may be connected together in series, or may be connected together in parallel. The structure for electrically connecting the plurality of cells together is not specifically limited. For example, the partition plate may also serve as a positive electrode bus bar, a negative electrode bus bar, or both positive and negative bus bars.

Each of the cell may be a rectangular battery.

The positive electrode plate and the negative electrode plate may be layered with a separator interposed therebetween, and comprise an electrode group.

The positive electrode lead may be replaced with a positive electrode current collector plate. The negative electrode lead may be replaced with a negative electrode current collector plate. As a result, a current collector resistance in the cell is reduced.

The positive electrode plate and the negative electrode plate may have any structures known as the structures of a positive electrode plate and a negative electrode plate, respectively, of a secondary battery (e.g., a lithium ion secondary battery). Further, the battery case, the gasket, the sealing plate, the positive electrode lead and the negative electrode lead may be made of any materials known as the materials for a battery case, a gasket, a sealing plate, a positive electrode lead and a negative electrode lead, respectively, of a secondary battery.

The release portion may be formed at a portion of the sealing plate extending in an axial direction of the battery case. In this case, too, the battery module shown in FIG. 2, etc. can be formed, and the gas released from a cell can be released to the exhaust duct.

### INDUSTRIAL APPLICABILITY

As explained above, the present disclosure is useful as power sources of vehicles, power sources of thermal storage, etc.

### DESCRIPTION OF REFERENCE CHARACTERS

1 cell
21 battery module
23 module case
27 battery chamber
29 exhaust duct
31 first exhaust duct portion
33 second exhaust duct portion
35 first outlet opening (outlet opening)
37 first inlet opening (inlet opening)
51 battery pack
57 connecting member
135 second outlet opening
137 second inlet opening
253 connecting member (plate)
255 hollow space
257 upstream side opening
259 downstream side opening
353 lower panel (panel)
355 second hollow space
357 opening (first opening)
359 release end (second opening)

1. A battery pack in which a plurality of battery modules are arranged, wherein
each of the battery modules includes a plurality of cells which are arranged in a case,
the case is separated into a battery chamber in which the plurality of cells are accommodated, and an exhaust duct for releasing an exhaust gas from any one of the cells through an outlet opening to an outside of the case,
the outlet opening is formed in a side surface of the case,
the battery modules are arranged in a direction to which the outlet opening is open,
a side surface of the case opposite to the side surface of the case in which the outlet opening is formed is provided with an inlet opening to which the exhaust gas released from the outlet opening of an adjacent battery module is introduced, and
the outlet opening is connected to the inlet opening of an adjacent battery module through a hollow connecting member.

2. The battery pack of claim 1, wherein
a first battery module, a second battery module, and a third battery module are sequentially arranged,
in each of the first battery module, the second battery module, and the third battery module, a second outlet opening different from the outlet opening is formed in the side surface of the case in which the outlet opening is formed,
a second inlet opening different from the inlet opening is formed in the side surface of the case in which the inlet opening is formed,
the inlet opening is located opposite to the outlet opening,
the second inlet opening is located opposite to the second outlet opening,
the outlet opening of the first battery module is connected to the inlet opening of the second battery module through the connecting member, and
the second outlet opening of the second battery module is connected to the second inlet opening of the third battery module through the connecting member.

3. The battery pack of claim 2, wherein
the second outlet opening of the first battery module, the second inlet opening of the second battery module, and the outlet opening of the second battery module are closed.

4. The battery pack of claim 1, wherein
the connecting member is a pipe.

5. The battery pack of claim 1, wherein
the connecting member is a plate having a hollow space,
the hollow space has a straight shape or a curved shape in plan view,
the hollow space includes an upstream side opening connected to the outlet opening of one of the battery modules which is located at an upstream side in a release direction of the exhaust gas, and a downstream side opening connected to the inlet opening of one of the battery modules which is located at a downstream side in the release direction of the exhaust gas, and
the upstream side opening is positioned at a location different from a location of the downstream side opening in a longitudinal direction of the hollow space.

6. The battery pack of claim 1, wherein
a second hollow space formed in a panel is connected to the outlet opening of a downstream side battery module located at the downstream side in the release direction of the exhaust gas,
the second hollow space has a straight shape or a curved shape in plan view,
the second hollow space includes a first opening connected to the outlet opening of the downstream side battery module, and a second opening from which the exhaust gas introduced to the first opening is released, and
the first opening is positioned at a location different from a location of the second opening in a longitudinal direction of the second hollow space.

7. The battery pack of claim 1, wherein
the inlet opening of an uppermost battery module in the release direction of the exhaust gas is closed.

8. The battery pack of claim 1, wherein
the outlet opening is open in a direction perpendicular to a direction in which the cells are arranged.

9. The battery pack of claim 1, wherein
the battery modules are stacked.
